(19) United States
(12) Patent Application Publication
(10) Pub. No.: US 2003/0160830 A1
(43) Pub. Date: Aug. 28, 2003

(54) Pop-up edictionary

(76) Inventor: Lee M. DeGross, Fort Lee, NJ (US)

Correspondence Address: Lee M. DeGross, 400 Park Place, #1H, Fort Lee, NJ, 07024, US

(21) Appl. No.: 10/081,579

(22) Filed: Feb. 22, 2002

(51) Int. Cl. G09G 5/00

(52) U.S. Cl. 345/808

(57) ABSTRACT

A digital pop-up space or spaces that appears when a cursor is placed over a difficult or hard-to-understand word or phrase on a computer screen (34).

The pop-up space contains dictionary elements and other relevent elements that help the reader understand the difficult word (42).

The dictionary elements include but are not limited to definitions, synonyms, antonyms, quotations, and etymologies.

The pop-up edictionary can contain images and moving images of all kinds (54). These elements represent options that may be used and organized to best assist the readers of a text.

The sources of the pop-up edictionary elements can either be from published works or from extemporaneous origins or mixed together in combination.

There can be pop-up edictionaries within pop-up edictionaries.

If there are multiple definitions presented, the intended meaning will be distinctly indicated (42).

Finally, the language or dialect in a pop-up edictionary can be different from the language in the main text.

### BACKGROUND

1. Field of Invention

This invention relates to the field of computers, specifically the creation of digital text and images on a computer screen.

2. Description of Prior Art

In this section, the lesser significant prior art will be discussed first and will progress to the more significant prior art. For purposes of brevity, the word “word” is taken to mean both single words and phrases. Similarily, the word “selection” is taken to encompass all of the various selection methods of a computer. These selection methods include keyboard, mouse click, touchscreen and other such selection tools.

Pop-up spaces are frequently encountered when using computer software. Many functions in software are represented by an icon button which is a pictorial representation meant to make it easy to recognize its meaning. For example, in Microsoft Word™, a popular word processor program, when the cursor is placed over the yellow folder icon, the word “Open” pops up next to it. Simply the action of placing the cursor over this icon is enough to produce the “Open” pop-up. The user does not have to click the mouse buttons to select it. This is very convenient and is a notable feature of this application's invention.

More examples of pop-ups from Microsoft Word™ include the brush icon which generates the “Format Painter” pop-up, the italicized “ABC checkmark” icon which generates the “Spelling and Grammar” pop-up, and the “can of spilling paint” icon which generates the “Fill Color” pop-up. These are only a few examples of the many pop-ups employed by Microsoft Word™.

In Microsoft Excel™, a spreadsheet software made by the same company that makes Microsoft Word™, many of the same icons are used with the same pop-ups. Two examples that are unique to Microsoft Excel™ are the mini-chart icon with the “Chart Wizard” pop-up and the “%” icon with the “Percent Style” pop-up. These are only two examples of the many pop-ups employed by Microsoft Excel™.

A major reason why these pop-ups are used is to save space. When space is not an issue, some icons have their word spelled out just beneath it. On the Yahoo™ website, an internet web browser, an envelope icon is displayed with “Check Email” beneath it. Pop-ups are unnecessary in these cases.

In American Online™, another internet web browser and internet provider, some pop-ups are used redundantly despite the fact that the word is already spelled out. For example, an icon with the words “My AOL” yields a “My AOL” pop-up when the cursor is placed over it.

These pop-ups represent minor prior art. The limitations of these pop-ups are obvious. They merely serve as a labeling method. These pop-ups make no attempt is to define the meanings of the icons or words using multiple sentences, complete or fragmentary. For a word or concept to be understandable, especially difficult ones, requires more than just labels.

Closely related to the above prior art examples are the icons representing entire software programs that are displayed on computer screens with Microsoft™ operating systems. When no software is currently onscreen, the software icons typically fill an otherwise blank screen.

The My Computer icon yields the “Displays the contents of your computer” pop-up when the cursor is placed over the icon. Similarly, the My Documents icon yields the “Stores your documents, graphics, and other files” pop-up. The Recycle Bin icon yields the “Contains deleted items you can permanently remove or restore” pop-up. The Network Neighborhood icon yields the “Displays all the computers on your network” pop-up.

These pop-ups with the full sentences are more developed than the preceding pop-up examples. However, these pop-ups are describing the function of single software icons standing alone. The pop-ups are not conveying the meanings of a word in the context of a sentence that is embedded in literature.

The next minor prior art is the method some word processors use to provide the meanings of words. On Microsoft Word™, currently the dominant word processor, the word must be selected first by having the cursor within it or highlighting it. Then, on the toolbars on top of the screen, the “Tools” button must be selected. Then “Language” is selected from a drop down menu and “Thesaurus” is available to be selected to find a clue to the word's meaning. Of course, the “Thesaurus” gives you synonyms of the selected word.

Currently, a dictionary is not available in Microsoft Word™. However, the steps to utilize it would presumably be similar as the steps to the thesaurus.

Obviously, the major disadvantage of the method used by Microsof Word™ is its unwieldiness and clunkiness. At least four selections from disparate locations are needed to find the synonyms of a word. The other notable disadvantage is the already mentioned absence of a dictionary in Microsoft Word™.

The first major prior art to be discussed is found on the www.Bartleby.com™ website for online books. Bartleby's™ method of looking up the meanings of words is very similar to the one described for Microsoft Word™. The only exception is that the word does not need to be selected.

In Bartleby's™ website, there are links labeled “Encyclopedia”, “Dictionary”, “Thesaurus”, “Quotations”, and “English Usage” on top of the page. If the user wishes to use these resources, the desired link must first be selected. An entirely new page is brought to the seen-and there is a search engine field in each category. Next, the word or phrase in question must be typed into the search engine fields and the “search” button must be selected. The requested information is then displayed in additional pages.

An alternative way to typing the words into these search engines is to use the copy and paste method. For the experienced user, this method saves a small amount of time. In copy and paste, a commonplace tool, the mouse manipulates the cursor to hightlight the word. By pressing a key on the mouse, a menu pops up with a “copy” selection that copies the words into memory.

The next step is to select a desired link, “Dictionary” for example, and place the cursor in the search engine box. The mouse key is pressed again to bring up the same pop-up menu and the “paste” button is selected. The “paste” selection pastes the copied words in memory into the search engine box. Finally, select the nearby “search” button to get the dictionary definitions, which appear on additional pages. In copy and paste with the mouse pad, the user never has to press the keys on the computer's keyboard.

Interestingly, the definitions from Bartleby.com come from an actual dictionary, in this case The American Heritage® Dictionary of the English Language: Fourth Edition. 2000©.

The primary weakness of finding definitions, synonyms, quotations, etc. with Bartleby.com™ is the same as Microsoft Word's™, namely its unwieldiness and clunkiness. At least five distinct steps need to be taken, and this includes the actual typing of the word into the search engine box. With the copy and paste method, the number of steps needed increases to at least a hefty nine times.

The last prior art to be described is found on Netlibrary.com™, another online website. The Netlibrary.com™ website uses a very unique, simple, and powerful method of looking up various meanings of words. In the first step, user has to make sure the tools menu is open by selecting the “Open Tools” icon found above the literature. The tools menu takes up a quarter of the screen space on the left hand side.

The user merely needs to double-click (press the mouse key twice quickly) on any word in the text to bring up the dictionary material. The dictionary menu box on the left side shows a full and detailed listing of the definitions and other related dictionary information of the selected word.

For example, the word “manifold” has ten different meanings, divided between the adjective, noun, and verb senses. A pronunciation key is listed and different spellings are shown. An etymological entry is also given. Remarkably, a sound speaker icon is present that will give the user an actual pronunciation over the computer's sound system.

Incidently, the same dictionary company used by Bartleby.com™ is also used for the Netlibrary.com™ website. Additionally, Netlibrary.com™ carries students' and childrens' versions of the dictionary. To restate, it is The American Heritage® Dictionary of the English Language: Fourth Edition. 2000©.

The primary strength of Netlibrary.com's™ dictionary method is that any word found in the text can be looked up. Even commonplace words like “an”, “the”, “I” and “many” are supplied with the full dictionary treatment.

Despite Netlibrary.com's™ merits there are several disadvantages. One problem is the location of the dictionary menu because it is away from the literature. The user is forced to divert his or her attention from the selected word and look to the left of the computer screen. The pop-up edictionary does not have this problem because its contents are supplied next to the selected word.

The dictionary menu box in Netlibrary.com™ also takes up valuable space, a quarter of the screen, that could be used for the literature and other purposes.

In addition, Netlibrary.com™ gives the same dictionary treatment to the same words, even if a word is used in a different context or sentence. Thus, if a sentence is connoting a word's distinct secondary meanings, this may not be immediately discernable to the unsuspecting reader. Netlibrary.com's™ bland democratic dictionary method gives few clues as to which of a word's multiple meaning is the intended one.

The last, albeit minor, fault of Netlibrary.com's™ dictionary method is the necessity of double-clicking a word, assuming a mouse is used. This is inferior to simply placing the cursor over the word with no clicking or double-clicking required.

This concludes the prior art section.

### SUMMARY

In accordance with the present invention a pop-up space containing dictionary elements appears when a computer cursor is placed over a word or phrase. The dictionary elements include and are not limited to definitions, synonyms, antonyms, pronunciations, usages, and quotations. The extensive use of images such as photographs, drawings, illustrations, and moving images such as film, video, and animation will be served, along with sound effects.

Objects and Advantages

Accordingly, several objects and advantages of my invention are:

(a) to provide meanings of words from professional dictionary sources or from extemporaneous sources and display them on a computer screen in a simple and convenient manner;

(b) to provide dictionary elements and other elements in pop-up spaces that are triggered when a cursor is placed over a signaled word;

(c) to provide a distinctive signal such as a red superscript “!” on a word to denote that a pop-up edictionary exists for the signaled word;

(d) to provide the pop-up edictionary without having to click or double-click the signaled word;

(e) to provide dictionary elements in pop-up spaces such as definitions, syllable breaks, pronunciations, parts of speech entries, synonyms, antonyms, etymologies, variants, usages, idioms, quotations, etc.

(f) to provide the dictionary elements of a word in an organized manner that may or may not involve subsequent clicks of the cursor from menu prompts that yield additional pop-up spaces;

(g) to augment the dictionary elements with other elements using imagery such as photographs, illustrations, paintings, drawings, charts, maps, diagrams, etc.;

(h) to augment the dictionary elements with other elements using imagery that involve movement or action such as films, videos, digital video works, animation, claymation, stop-action, etc.;

(i) to make it clear to the computer user which meaning of a signaled word is the intended meaning if there are multiple meanings of a word;

(j) to calibrate the level of difficulty or sophistication of the contents of the pop-up edictionaries with respect to the age of the intended audience;

(k) to reduce overexposure by selecting only difficult or hard-to-understand words with respect-to the age of the intended audience to exhibit the pop-up edictionaries, rather than all of the words in a text;

(l) to reduce digital file and memory space due to this selectivity;

(m) to speed up download time if the internet is involved due to this selectivity;

(n) to offer pop-up edictionaries within pop-up edictionaries in occasions when the contents of a signaled word contain difficult or hard-to-understand words which are also signaled and possess their own pop-up edictionaries;

(o) to offer pop-up edictionary elements in languages and dialects different from the language used in the text; and

(p) to apply the pop-up edictionary to any and all of the various languages and dialects of the world.

Further objects and advantages of my invention will become apparent from a consideration of the drawings and ensuing description.

### DRAWING FIGURES

FIG. 1 shows text on a web browser with the cursor over the word “independent”.

FIG. 2 shows a pop-up edictionary showing two definitions of “independent” with the intended meaning highlighted.

FIG. 3 shows a pop-up edictionary showing four synonyms of “independent”.

FIG. 4 shows text on a web browser with the cursor over the word “tigers”.

FIG. 5 shows a pop-up edictionary showing one definition of a “tiger”.

FIG. 6 shows a pop-up edictionary showing one image of a “tiger”.

FIG. 7 shows an alternative pop-up edictionary showing the image of a tiger alone without further dictionary elements or menus.

FIG. 8 shows text on a web browser with the cursor over the word “pro tempore”.

FIG. 9 shows a pop-up edictionary showing one definition of “pro tempore”.

FIG. 10 shows a pop-up edictionary showing one etymology of “pro tempore”.

FIG. 11 shows a general flowchart for the pop-up edictionary.

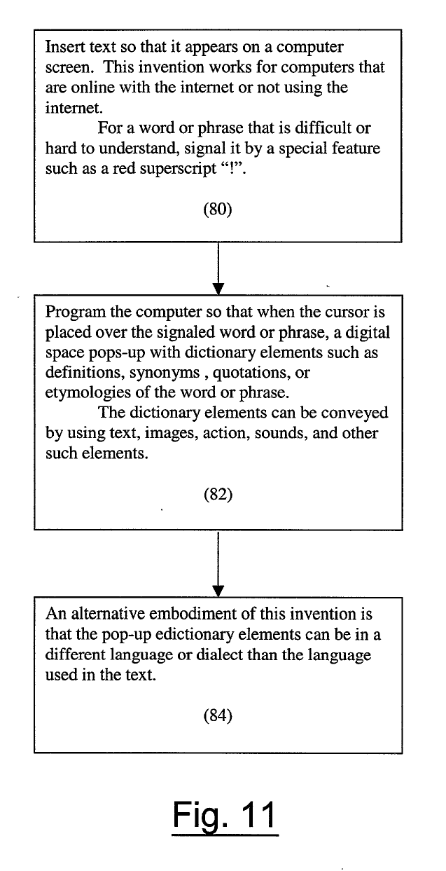

Reference Numerals In Drawings

| | | | |
|---|---|---|---|
| 20 | web browser menu bar | 22 | web browser buttons |
| 24 | Uniform Resource Locator box | 26 | web browser features |
| 28 | scroll bar | 30 | web browser information, button, and icon bar |
| 32 | operating system button bar | 34 | mouse pointer's first position |
| 36 | mouse pointer's second position | 38 | mouse pointer's third position |

40 1^{st} pop-up edictionary with menu and “definitions” selected

42 2^{nd} pop-up edictionary showing two definitions of “independent”

44 1^{st} pop-up edictionary with menu and “synonyms” selected

46 3^{rd} pop-up edictionary showing four synonyms of “independent”

48 4^{th} pop-up edictionary with menu and “definitions” selected

50 5^{th} pop-up edictionary showing one definition of “tiger”

52 4^{th} pop-up edictionary with menu and “image” selected

54 6^{th} pop-up edictionary showing an image of a tiger

55 7^{th} pop-up edictionary showing only an image of a tiger and nothing else

56 8^{th} pop-up edictionary with menu and “definition” selected

58 9^{th} pop-up edictionary showing one definition of “pro tempore”

60 8^{th} pop-up edictionary with menu and “etymology” selected

62 10^{th} pop-up edictionary showing an etymology of “pro tempore”

80 first step in general flowchart for the pop-up edictionary

82 second step in general flowchart for the pop-up edictionary

84 third step in general flowchart for the pop-up edictionary

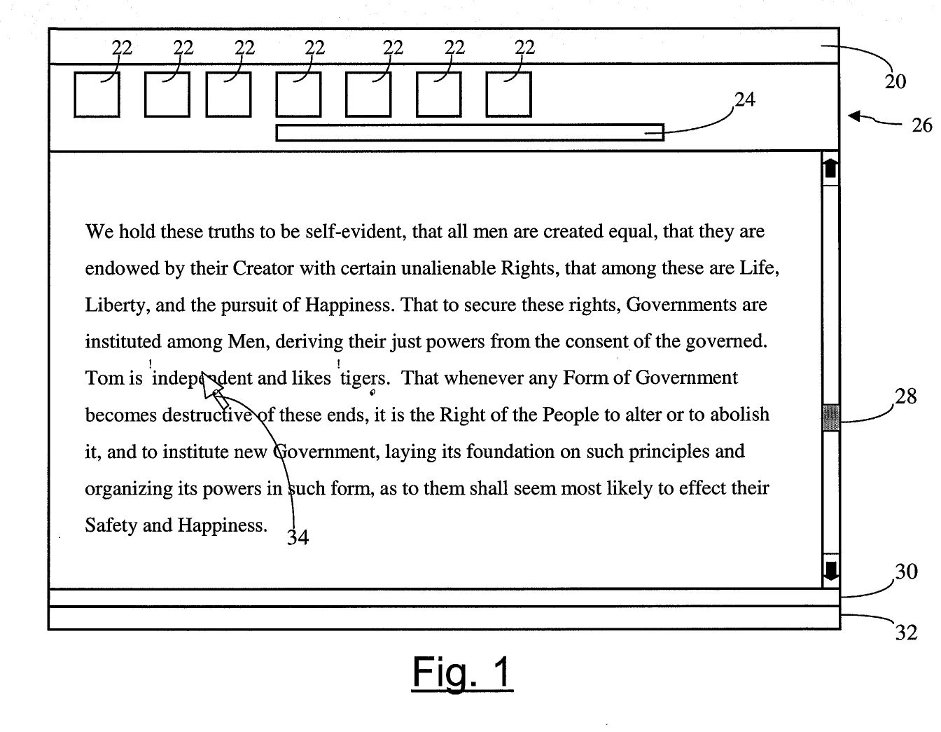

Description and Operation—Preferred Embodiment—FIGS. 1, 2, 3, 4, 5, 6, 7, 8, 9, 10

The pop-up edictionary invention is a computer and internet creation and its purpose is to provide dictionary elements and other relevant elements for a word in pop-up spaces when a cursor is placed over it. A detailed description of the pop-up edictionary and a preferred embodiment will be discussed later in this section. First a static physical description of a computer and the internet will be given.

The computer is an ubiquitous machine and drawings of its physical hardware will not be included in this application. Computers have undergone constant changes in form, speed, and memory size and this will continue as computers evolve presently and in the future.

Computers come in all shapes and sizes but share four essential characteristics consisting of the input, processing, memory, and output functions.

Computers range in size from small hand-size personal digital assistants (PDA's) to a briefcase-like laptop PC (personal computer) to a typical desktop PC. Larger computers like workstations and mainframes do not count for this invention because their size is inappropriate for the intended audience of casual computer and internet users.

The descriptions will start with the largest computers (the desktop computer) and work downwards in size to end with the PDA's. All of these computers have internet capabilities but it must be emphasized that this invention is applicable to both computers without the internet and computers that have the internet. This invention is useful as long as text, literature, writings, and even images are present on a computer screen.

The desktop computer (or desktop microcomputer) looks like a television screen sitting atop or beside a square-looking slab about the size of a small suitcase. The television screen is actually a computer monitor and is the primary output device. The computer monitor shows text, images, and action on the screen. The suitcase slab is actually a box that houses the processing and memory parts. The box, also known as the Central Processing Unit (CPU), is often placed elsewhere such as on the floor or on a desk standing upright.

Positioned in front of the monitor and CPU is a flat slab with many buttons called a keyboard. The keyboard is an input device that enters letters, numbers, and other symbols. The mouse is another input device that allows the user to move the cursor to select, point, and draw on the computer screen. The mouse is a very common device and is usually the size of a person's palm. The mouse is placed on a flat surface (like a desk) so when it is moved, the cursor on the computer screen also moves correspondingly. It usually has a few buttons that allow the cursor on the computer screen to “click” or select a particular spot on the screen.

The last major desktop device, the printer, is an output device that comes in all shapes, sizes, and types. The average printer is typically a laser printer shaped like a medium-sized moving box. The printer's function, as the name implies, is to print or produce the hard copy (paper) output of the computer's work. The printer, though not essential to the invention, is included for the sake of thoroughness.

The laptop PC, by now a very common machine, combines all of the features or devices found on a desktop PC system described above (with the current exception of a printer) into one single unit that is typically the size of a large notebook. The laptop is designed to be a portable PC and has a very thin monitor or screen that, when closed, is usually positioned face down facing the keyboard. A hinge or other similar device typically combines the keyboard and monitor and the laptop looks like an open clamshell when opened.

The mouse used with a desktop PC is often replaced on a laptop PC by contraptions that serve the same purpose. Laptops are powered like a desktop PC using an electrical outlet, sometimes in combination with batteries (usually rechargeable). Virtually all laptops being built now are able to access the internet, often by wireless means.

Personal digital assistants (PDA's), have the portability of laptops but are designed to be small enough to fit in a user's hand or a shirt pocket. Many PDA's are pen-based, meaning that a pen-like stylus is used to do the functions of a keyboard and a mouse by touching the PDA's monitor. PDA's are primarily organizers that allow a user to do scheduling functions, act like a notepad, store phone numbers, calculate, and a host of other uses.

Some PDA's are now capable of accessing the internet, often by wireless means, but the monitor usually shows just a portion of a website's contents. The PDA's monitor may get the rest of the website's contents by using a scrolling function to go across, or up, and down. Ambitious attempts are being made to allow a PDA's monitor to display 100% of a websites contents onto its small screen.

Newer PDA's are being built to combine its features with various other electronic gadgets like cellular phones, pagers, and the like. Cellular phones are portable wireless telephones. Pagers are small devices that alert the user to return a call, or receive and send a message.

The internet will now be described briefly. The idea of the internet is simple, a vast network of computers of many types that are connected and are able to interact with one another. The whole of the internet could probably be written about in a series of large books. For this invention's purpose the following definition of the internet is from the IBM Dictionary of Computing. It defines the internet as, “A wide area network connecting thousands of disparate networks in industry, education, government, and research. The Internet network uses TCP/IP as the standard for transmitting information.”

The TCP/IP is defined by the same dictionary as, “Transmission Control Protocol/Internet Protocol. A set of communication protocols that support peer-to-peer connectivity functions for both local and wide area networks.”

The most relevant feature regarding the internet for this invention is the World Wide Web (WWW). The WWW, with its ability to handle graphics, multimedia, and hypertext links is included here since the pop-up edictionary will mostly use WWW website addresses and capabilities. The internet spans many countries, consists of thousands of networks, has millions of users, and will continue to grow and improve.

The pop-up edictionary invention is not limited to WWW websites. The invention can be used in future generation World Wide Webs and future internets employing internet/television hybrids.

The WWW is navigated or surfed with the help of a web browser. A website's address is accessed when its URL (Uniform Resource Locator) or domain name is invoked on the browser's domain name locator. For WWW websites, their address begins with the prefix “www” as in www.websitename.com. The suffix “.com” is a government-created categorization representing the commercial industry. Other examples of these suffixes are “.net”, “org”, “.edu”, “.mil” and “.gov”. More such suffixes will undoubtedly be created.

A basic description of the computer hardware and its ability to access the internet and the internet itself has been given. The remainder of this description and operation section will describe the eleven drawings that are included in this RPA.

A description of the preferred embodiment of the pop-up edictionary will begin. The essence of the pop-up edictionary is simple. Wherever there is text on a computer screen, the pop-up edictionary will make it simple to look up definitions and meanings of difficult words. The reader simply places a cursor over the word, and a pop-up space containing the definition and other meanings of the word appears. There is no clicking or double-clicking of the mouse. The difficult word can signal the presence of it's pop-up edictionary with a sign such as a superscript “!” next to the word. To further distinguish the signal, it can be colored red, for instance.

While no clicking is required to trigger the initial pop-up space, additional clicks may be used to help the reader make a choice among a menu of choices. The clickless drag method may also be used to help make a choice. The drag method slides the cursor from one choice to the next choice or the end result without clicking.

What is a difficult word? The answer to that is that it depends on the age of the intended audience. Several broad categories are used loosely to define such age groups. For example, there is the pre-school audience, the elementary school audience, the junior high school audience, the high school or young adult audience, the adult audience, and perhaps the senior citizens audience.

Each category can have subcategories, especially the adult audience where there are innumerable professional occupations. A few examples include physicians, computer programmers, carpenters, airplane pilots, and organic biologists.

In the preferred embodiment, the pop-up space's dictionary content is not limited to just the definitions of the signaled word. The definition can be joined by other dictionary elements that give additional meanings and information to the signaled word. Among these are syllable breaks, pronunciation keys, parts of speech entries, synonyms, antonyms, etymologies, usage senses, variant senses, idioms, homographs, suffix and prefix senses, example sentences, and quotations. The possibilities are not limited to these and the stated ones are merely the prominent examples of the many elements of a dictionary.

Images such as photographs, illustrations, drawings, digital photos, paintings, charts, maps, and diagrams can be used to augment these dictionary elements or exist alone without them.

The use of action and movement can also be used in the pop-up edictionary. Action images such as films, videos, digital video works, animation, claymation, and stop-action can be used. The use of the computer's sound system is another element that will be utilized, especially for the pronunciation of a word.

A note about the pop-up space itself, the space need not always be strictly a rectangular box. The pop-up space is a simple way of describing the background space that exhibits the pop-up edictionary elements. The pop-up space can take many forms, such as overlapping boxes, multiple boxes, boxes of many shapes and sizes, boxes with curvy lines, boxes that are not boxes but are round or oval or any other shape. The spaces can even look like billowy clouds or other such images.

The next element deals with contextual meaning. If a word has more than one meaning, the context in which it is used determines which meaning is meant. Thus, the pop-up edictionary can help matters by highlighting the correct meaning of a signaled word if there are several meanings presented.

The last element to be discussed is the source of the dictionary elements and the other elements like images and action images. The sources of these elements are twofold.

The first source of the pop-up edictionary elements can be from published or professional works like a standard dictionary and a thesaurus.

The second source can be from extemporaneous origins like the ad hoc creativity of various people like writers, editors, and artists.

Of course, not all of the above mentioned elements are used at once. The elements mentioned merely represent options that can be used to best assist a reader of the text. The elements that are chosen depends, to a large degree, on the age and makeup of the intended audience. The wishes of the writers, editors, producers, advertisers, and other people may also be factors.

Three examples of the pop-up edictionary will be given for this patent application. The first and second examples have young children as the intended audience. The third and last example targets the adult audience.

In these examples, the text is presented as if it were downloaded from the internet. Many of the internet browser features 20, 22, 24, 26, 28, 30, 32 can be seen from the drawings. They are the web browser menu bar 20, web browser buttons 22, Uniform Resource Locator box 24, web browser features 26, scroll bar 28, web browser information, button, and icon bar 30, and operating system button bar 32.

However, it must be re-emphasized that the pop-up edictionary is also applicable to text found offline of the internet on a computer. These texts are software packages purchased from retail stores or other sources and are designed to be run independent or in combination with the internet.

FIG. 1 shows the sentence “Tom is independent and likes tigers.” in the text. The text is part of a website intended for young children. The words “independent” and “tiger” are both signaled with a red superscript “!”. The color red cannot be seen from the black and white drawing. The sentence is surrounded by filler text borrowed from The Declaration of Independence.

In this case, given the young age of the audience, the unsophisticated dictionary elements will be from extemporaneous sources.

In FIG. 1 the word “independent” has a cursor placed over it, indicating that a pop-up edictionary is soon to follow 34.

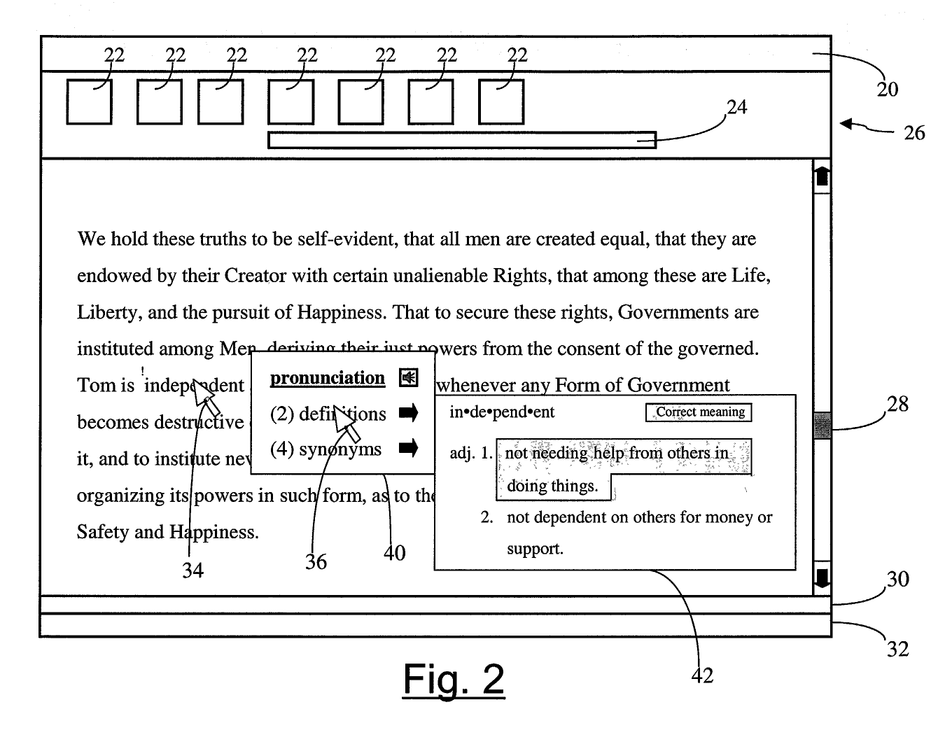

FIG. 2 shows that the dictionary elements chosen for “independent” are pronunciation (with a speaker icon), definitions (two), and synonyms (four). These components can be seen in a menu from the initial pop-up edictionary 40. From the menu, the pronunciation of “independent” is made by loudspeaker by selecting the underlined “pronunciation” link.

FIG. 2 shows the “(2) definitions” link with a cursor placed over it 36 and triggers the next pop-up edictionary 42. In this pop-up 42, two definitions are given along with other dictionary elements like syllable breaks and a part of speech designation. Since there are more than one definition supplied, the intended meaning is made clear by being highlighted 42.

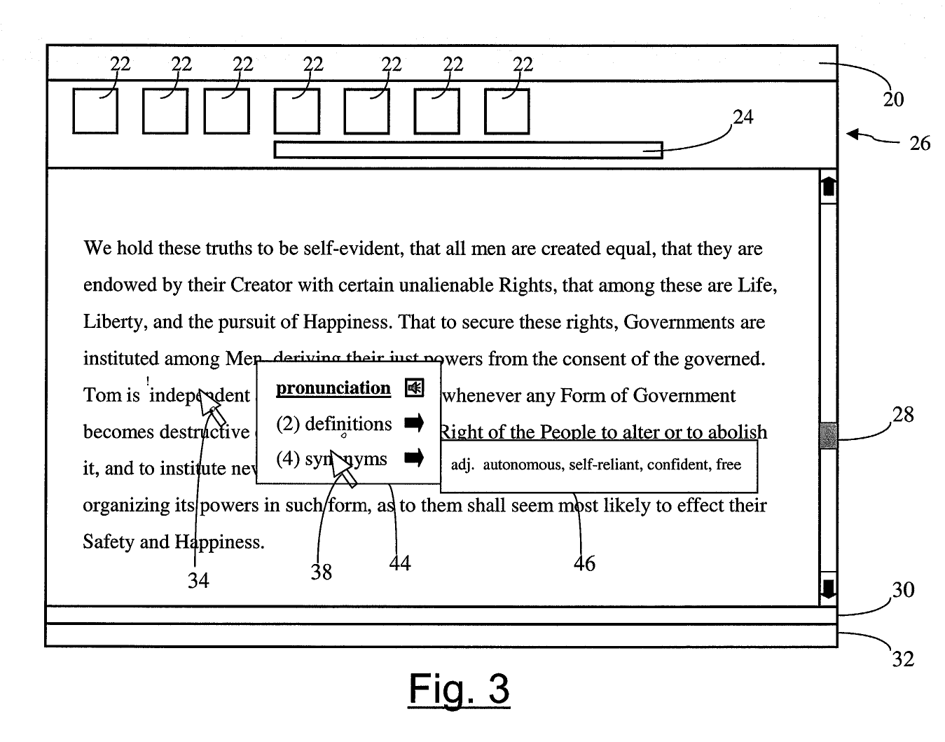

FIG. 3 shows the “(4) synonyms” link with a cursor placed over it 38 and triggers the next pop-up edictionary 44. In this pop-up 44, four synonyms of “independent” are supplied along with a parts of speech designation 46. This concludes the pop-up edictionary treatment for “independent”.

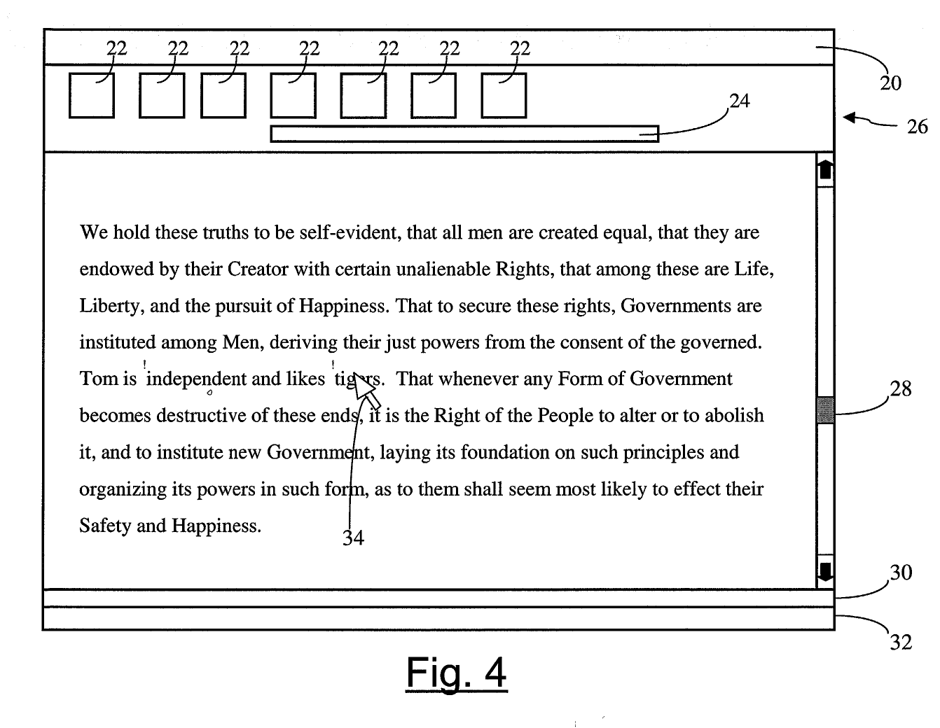

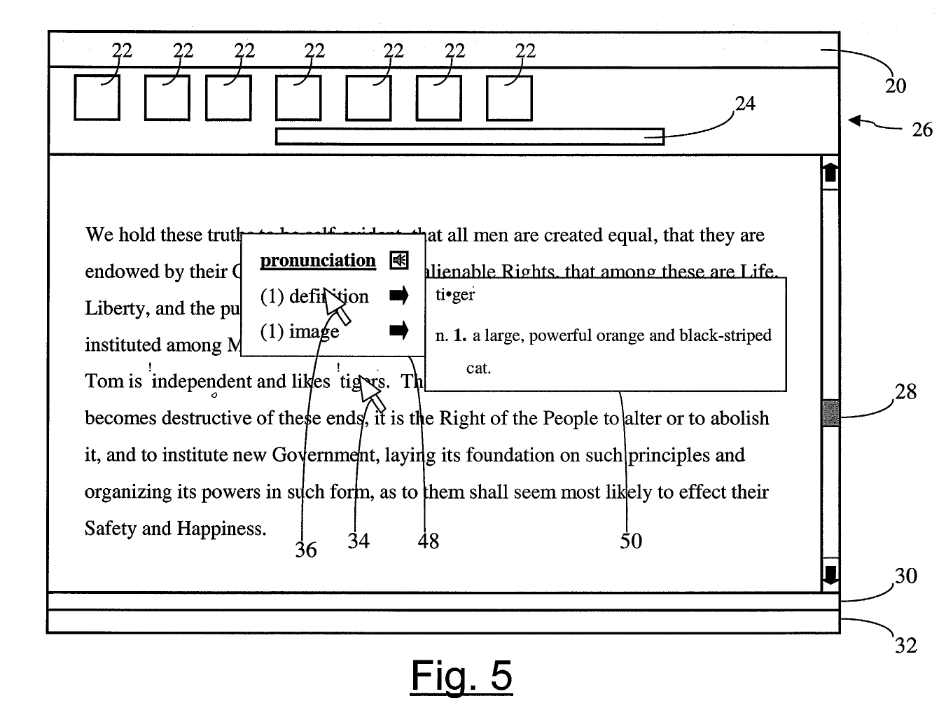

FIG. 4 shows the next word “tigers” with a cursor placed over it 34. FIG. 5 shows the pop-up edictionary that immediately follows 48. This pop-up contains a menu similar to the one for “independent” 40 consisting of pronunciation, definition, and image choices. FIG. 5 shows the “(1) definition” link with a cursor placed over it 36. This triggers the next pop-up edictionary 50 which contains one definition, a syllable break, and a parts of speech designation for the word “tiger”.

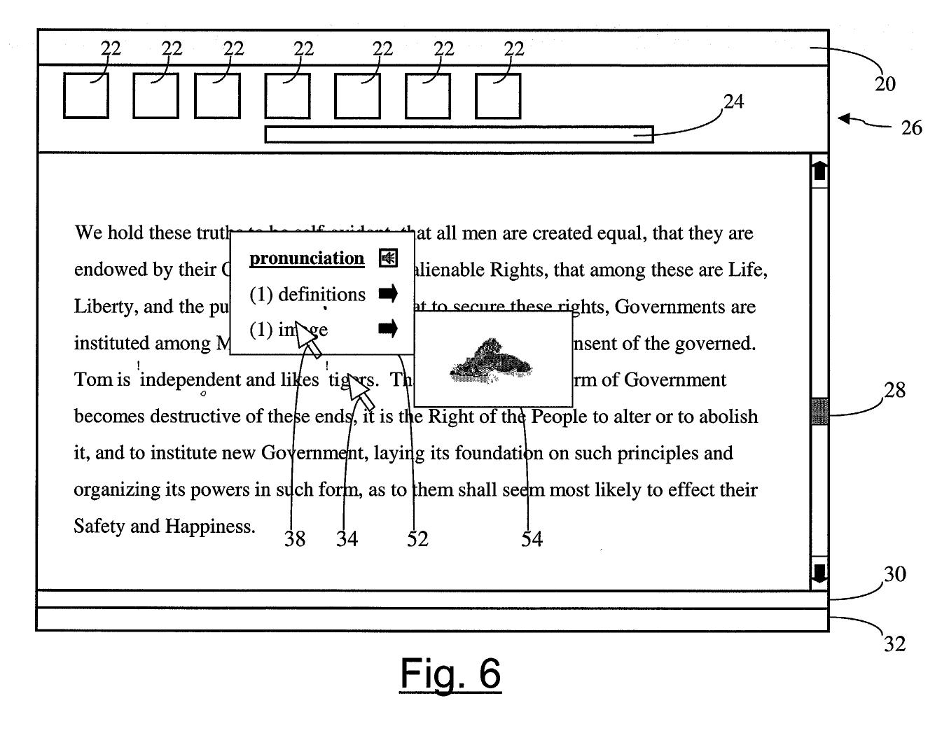

FIG. 6 shows the “(1) image” link with the cursor placed over it 38 in the same menu 52 used previously for “tiger” 48. This triggers the next pop-up edictionary which shows an image of a tiger 54. This concludes one method of handling the word “tiger”.

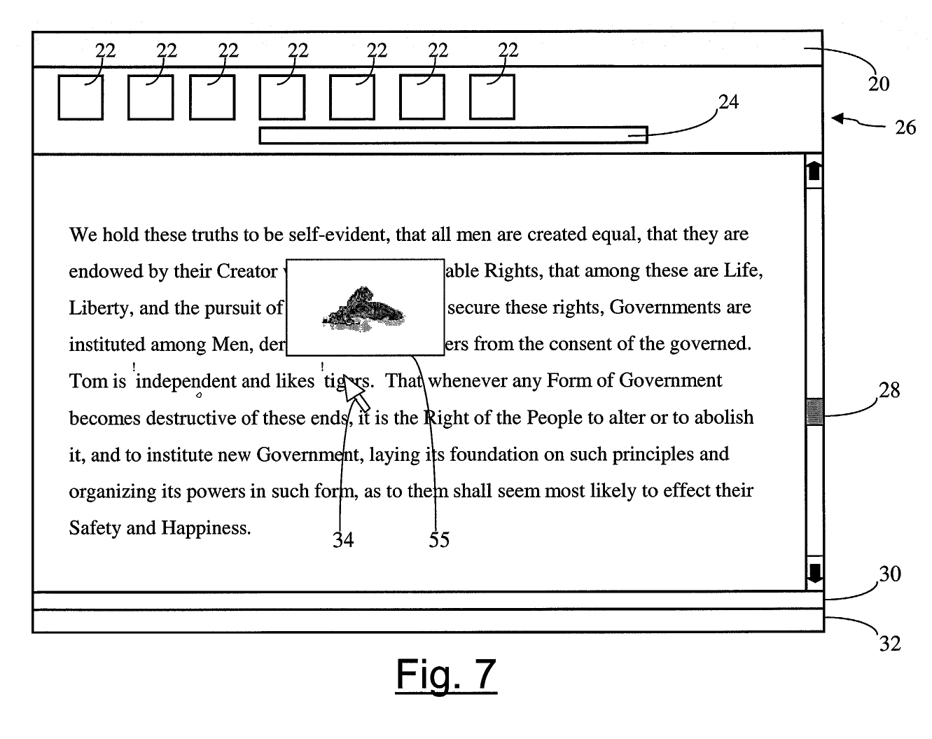

FIG. 7 presents a simpler alternative method of conveying the meaning for “tiger”. Rather than offering two pop-up edictionaries 52, 54, FIG. 7 shows just one with an image of the tiger unadorned with anything else 55. For young children, perhaps this method will be more appropriate than the methods in FIGS. 5 and 6. FIG. 7 is important because it stresses that there is more than one way of handling a difficult word.

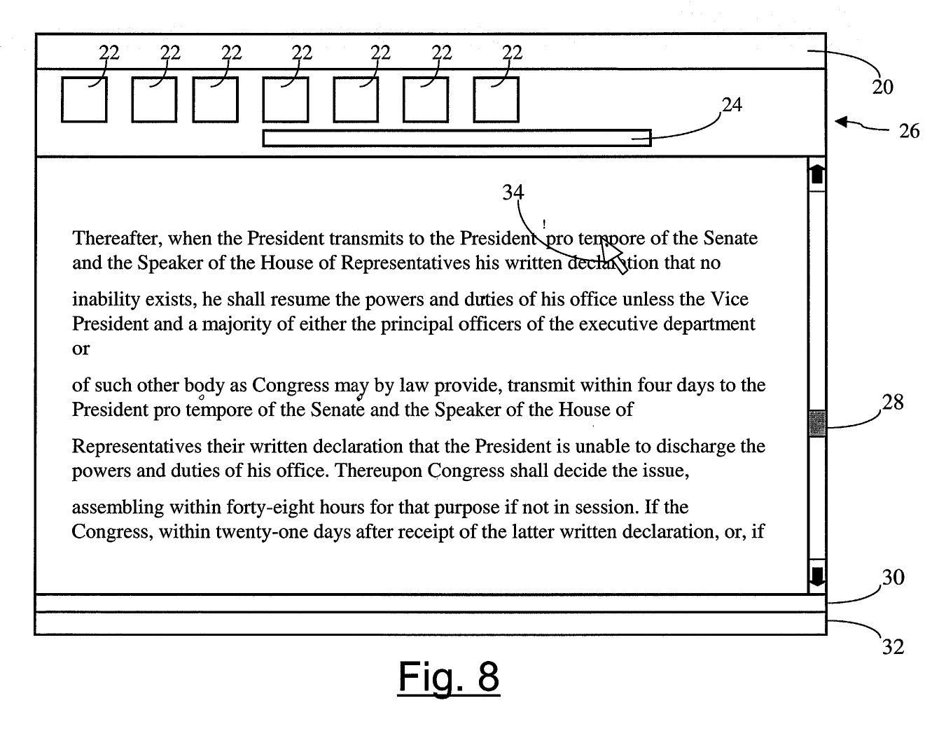

FIG. 8 presents an entirely new situation. The intended audience for FIG. 8 is an adult one. The text is borrowed from the twenty-fifth amendment from The Constitution of the United States of America. The first sentence displayed contains the hard-to-understand word “pro tempore” which is signaled with a red superscript “!”. FIG. 8 shows the cursor placed over “pro tempore” 34.

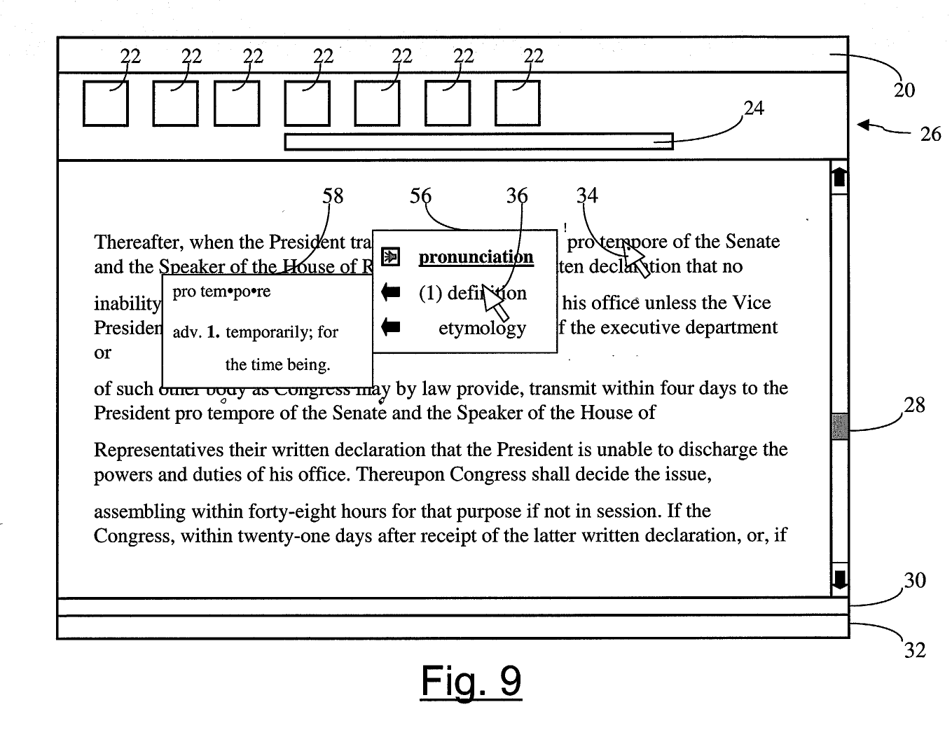

FIG. 9 shows the initial pop-up edictionary for “pro tempore” which is a menu similar to the ones discussed previously 56. The dictionary elements are the usual pronunciation link, a definition, and an etymology. FIG. 9 shows the cursor placed over the “(1) definition” link 36. FIG. 9 shows a second pop-up edictionary containing a syllable break key, a parts of speech designation, and a definition for “pro tempore” 58.

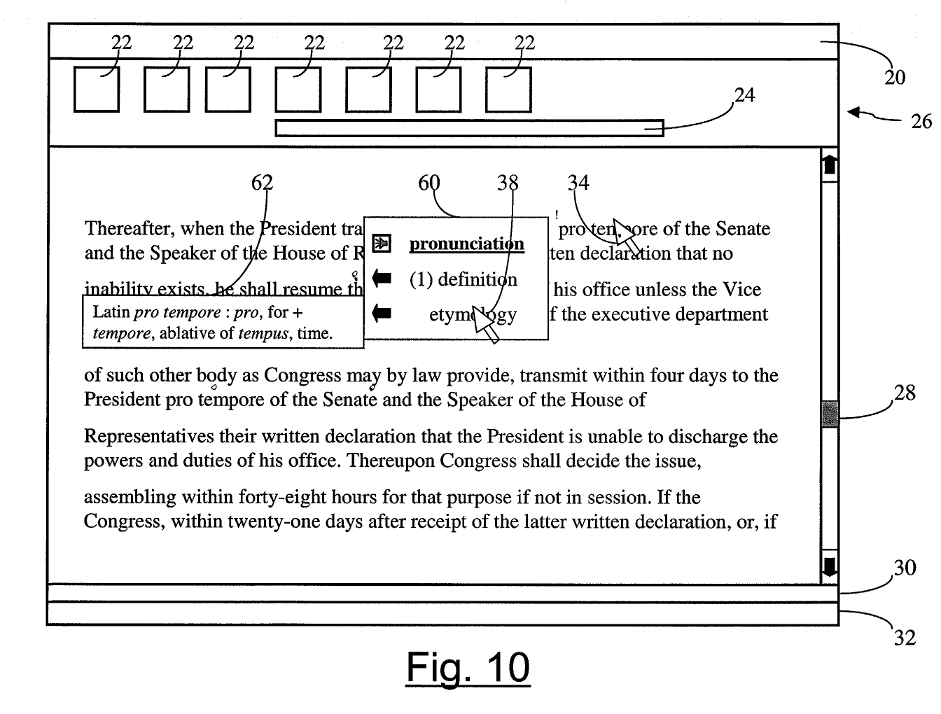

Since this is an adult audience, it would be prudent that the source of the dictionary elements be from a published dictionary. In FIGS. 9 and 10, the wording of the definition and etymology is changed slightly due to copyright concerns.

FIG. 10 shows the same initial pop-up edictionary 60 as in FIG. 9. FIG. 10 shows a cursor placed over the link “etymology” 38 and triggers a second pop-up edictionary 62. The second pop-up edictionary shows an etymology for “pro tempore” 62.

Description and Operation of Additional Embodiments

One additional embodiment is to provide a pop-up edictionary for all words rather than just for difficult or hard-to-understand words. This presents a unique problem because the cursor will likely be triggering pop-ups everywhere it goes. Thus, if this embodiment is used it would be wise to require a click or double-click in order to trigger a pop-up edictionary.

Another additional embodiment is to provide pop-up edictionaries within pop-up edictionaries. If there is a difficult word residing in one pop-up edictionary, another pop-up edictionary can be created to service the difficult word. Theoretically, this can be repeated indefinitely. However, information overload concerns and space constraints will limit this practice to just a handful of times, at the most, for each original difficult word.

The last additional embodiment concerns different languages. The pop-up edictionary is capable of displaying in its contents any language or dialect in the world. Conversely, the language in the text can be in the same language as used in the pop-up edictionary, or it can be any other different language or dialect in the world.

Description and Operation of Alternative Embodiment

An alternative embodiment to this invention is to use the preferred embodiment in combination with other methods of looking up meanings of words. If the goal is that all words must be provided definitions, this combination could be more effective than the unwieldy method described in the additional embodiment. In this case, only difficult words will have a pop-up edictionary and all other words can be looked up using other methods. For example, the pop-up edictionary preferred embodiment can be used in combination with the methods used in Netlibrary.com™ and Bartleby.com™.

Conclusion, Ramifications, and Scope of Invention

Thus the reader will see that the pop-up edictionaries of this invention provides an instant convenient way of acquiring the various meanings of difficult words found in texts on a computer screen. If the reader is in the dark about the meaning of something that is being read, this invention will help matters by providing these pop-up edictionaries.

The reader simply places the cursor over the word or phrase without clicking to instantly get the assistance of a pop-up edictionary.

While my above description contains many specificities, these should not be construed as limitations on the scope of the invention, but rather as an exemplification of one preferred embodiment thereof. Many other variations are possible. For example, the above description mostly deals with a word's direct meaning as if a dictionary entry were directly inserted in the pop-up edictionary. A variation of this would be to insert, in the pop-up edictionary, any helpful information that one does not ordinarily see in a standard dictionary.

The term “dictionary” meant in this patent application is both specific, as in the standard grammatical dictionary, and broad.

The broad scope of the word “dictionary” meant here includes many reference works like almanacs, encyclopedias, compilations, various subject oriented dictionaries, treatises, directories, and monographs. Any other works that serve the purpose of being primary sources of many terms are legitimate with the word “dictionary”.

Many books use their margins to place various assorted information of all kinds. The pop-up edictionary can assume this role by displaying these assorted information in their pop-up spaces.

Examples of these would be to remind the reader of an important date that is related to the corresponding text. It can contain trivia that is related to the corresponding text. It can refer the reader to a different page or different location of a book. It can refer the reader to a source of information. It can contain references cited and bibliographic information.

Most commonly, the pop-up edictionaries can contain photographs or illustrations with accompanying captions that would normally appear in a book's margins.

Furthermore, instead of limiting the pop-up edictionary to just a word or phrase, entire sentences or paragraphs can have their own pop-up edictionaries. Their pop-ups could reinterpret, offer additional information, give another perspective about the sentence or paragraph.

Accordingly, the scope of the invention should be determined not by the embodiments illustrated, but by the appended claims and their legal equivalents.

I claim:

1. A means for conveniently providing dictionary elements and other relevent elements of a word or phrase for computer users, comprising:
(a) said computer
(b) text displayed on the computer's screen
(c) a cursor present on the computer's screen
whereby said dictionary elements and said other relevant elements for said word or phrase are presented in pop up digital spaces when said cursor is placed over said word or phrase in said text
2. wherein said dictionary elements include but are not limited to definitions, pronunciation keys, syllable breaks, parts of speech entries, synonyms, antonyms, homographs, usages, variants, idioms, quotations, and etymologies
3. wherein said pop up digital spaces can contain various relevent images and moving images that help said computer users such as photographs, illustrations, paintings, charts, diagrams, films, videos, digital video works, animation, claymation, stop action, et cetera
4. wherein said pop up digital spaces can be menu driven and utilize the drag and selection methods of said cursor to select various choices in the menus
5. wherein if said definitions contain more than one meaning of said word or phrase, the intended contextual meaning of said word or phrase will be highlighted or otherwise distinguished
6. wherein the sources of said dictionary elements and said images or moving images elements can either be from published or professional works, or from extemporaneous origins, or from a combination thereof
7. wherein said dictionary elements and said images or moving images elements are to be used judiciously and not always all at once
8. wherein said pop up digital spaces can themselves contain said pop up digital spaces and so on, creating pop up edictionaries within said pop up edictionaries
9. wherein a language or dialect used in said pop up digital spaces can be different from the language used in said text
10. wherein said language or dialect used in said pop up digital spaces and the language used in said text can be any and all the languages in the world.
